(19) United States
(12) Patent Application Publication
(10) Pub. No.: US 2006/0121801 A1
(43) Pub. Date: Jun. 8, 2006

(54) High speed wired media connector with symmetric PCB interface

(76) Inventor: Neven Pischl, Santa Clara, CA (US)

Correspondence Address: GARLICK HARRISON & MARKISON LLP, P.O. BOX 160727, AUSTIN, TX, 78716-0727, US

(21) Appl. No.: 11/034,670

(22) Filed: Jan. 13, 2005

Related U.S. Application Data
(60) Provisional application No. 60/632,798, filed on Dec. 2, 2004.

(51) Int. Cl. H01R 13/73

(52) U.S. Cl. 439/894

(57) ABSTRACT

A wired media connector includes a body, a receptacle, a plurality of isolation transformers, and a Printed Circuit Board (PCB) interface. The receptacle includes a plurality of signal line contacts formed to exactly meet a plurality of signal line contacts of a wired media plug. Each isolation transformer includes a primary side having a pair of primary differential signal line connections and a secondary side having a pair of secondary differential signal line connections and a center tap. The PCB interface is formed on the body and has a plurality of PCB interface signal line groups. Each PCB interface signal line group includes a pair of PCB differential signal line connections communicatively coupled to a pair of secondary differential signal line connections of a corresponding isolation transformer and a center tap PCB connection communicatively coupled to the center tap of the secondary side of the corresponding isolation transformer.

### CROSS REFERENCE TO RELATED APPLICATION

This application claims priority to U.S. Provisional Patent Application Ser. No. 60/632,798, filed Dec. 2, 2004, which is incorporated herein by reference for all purposes.

### BACKGROUND

1. Technical Field

The present invention relates generally to wired communications; and more particularly to a connector that couples wired media to a printed circuit board.

2. Related Art

Communication systems are well known. Communication systems include both wired communication systems and wireless communication systems. Wired communication systems include the Public Switched Telephone Network (PSTN), Wide Area Networks (WANs), Local Area Networks (LANs), and other networks that use wired or optical media for the transmission of data. Wireless communication systems include cellular telephone systems, satellite communication systems, Wireless Local Area Networks (WLANs), Wireless Wide Area Networks (WWANs), Wireless Personal Area Networks (WPANs), and other networks that employ a wireless link between a serviced terminal and a network infrastructure. Of course, many communications are serviced using a combination of wireless communication systems and wired communication systems.

Wired communication systems typically include routers, switches, computers, or other computing devices that are intercoupled by wired media. Wired media may include electrical cabling, optical fiber cabling, or another type of cabling. Wired media typically includes a plurality of conductors that carry signals, ground wires, shielding, and jacketing. One example of such wired media is the RJ-45 media commonly used in Ethernet Local Area Network (LAN) systems. RJ-45 media includes four pairs of conductors. These four pairs of conductors typically carry differential signaling. The RJ-45 (and other media) includes RJ-45 plugs at each end. These plugs are received by RJ-45 connectors that typically communicatively couple the conductors to a Printed Circuit Board (PCB), through magnetics, which typically include transformers, chokes and additional filtering (e.g. inductors, capacitors, resistors). The PCB includes integrated circuits that service communications supported by the RJ-45 media, e.g., 10 Mbps Ethernet, 100 Mbps Ethernet, 1 Gbps Ethernet, etc. The PCB may service a router, a switch, a personal computer, a laptop computer, or another computing device.

As the rate at which communications are serviced increases so does the demands placed on the wired media, the plugs that service the wired media, and the connectors that service the wired media. The wired media is typically exposed to Electro Magnetic Interference (EMI) which adversely impacts the performance of the system. Further, impedance matching in high bandwidth systems is very important. Prior plugs and connections typically introduced reflections due to poor characteristic impedance matching. Further, prior plugs and connections typically allowed for significant cross-talk, which further degraded system performance. Thus, a need exists for improvements in the structure and operation of wired media connectors.

### SUMMARY OF THE INVENTION

In order to overcome the shortcomings of the prior wired media connectors, among other shortcomings, a wired media connector constructed according to the present invention includes a body, a receptacle, a plurality of isolation transformers, and a Printed Circuit Board (PCB) interface. The receptacle is formed in the body and includes a plurality of signal line contacts formed to exactly meet a plurality of signal line contacts of a wired media plug. The plurality of signal contacts correspond to a plurality of sets of differential signal lines. The plurality of isolation transformers may be contained within the body. Each isolation transformer includes a primary side having a pair of primary differential signal line connections communicatively coupled to a corresponding set of differential signal lines of the plurality of sets of differential signal lines and a secondary side having a pair of secondary differential signal line connections and a center tap. The PCB interface is formed on the body and has a plurality of PCB interface signal line groups. Each PCB interface signal line group includes a pair of PCB differential signal line connections communicatively coupled to the pair of secondary differential signal line connections of a corresponding isolation transformer and a center tap PCB connection communicatively coupled to the center tap of the secondary side of the corresponding isolation transformer.

The secondary side of each isolation transformer in combination with corresponding signal contacts of the receptacle may have a characteristic impedance matched to a serviced wired media. The wired media connector may include, for each isolation transformer, a capacitor having a first side coupled to the center tap of the isolation transformer, and a second side coupled to a ground of the wired media connector. Further, the wired media connector may include, for each isolation transformer, a capacitor having a first side coupled to the center tap of the isolation transformer and a second side coupled to a corresponding center tap PCB connection. The wired media connector may also include filtering circuitry coupled to the primary side of the plurality of isolation transformers.

According to one aspect of the present invention, the plurality of PCB interface signal line groups may be separated by a first distance D. Further, with this aspect, the pair of PCB differential signal line connections of each PCB interface signal line group may be separated by a second distance d. In such case, the first distance D is substantially greater than the second distance d. Further, with this aspect, the first distance D may be at least three times the second distance, d. For each PCB interface signal line group, the pair of PCB differential signal line connections may be symmetric about a PCB interface “intra-group” symmetry line that bisects the center tap PCB connection. Such “intra-group” symmetry enhances balance of the differential signal line connections and enhances Electro Magnetic Interference (EMI) protection resistance.

According to another aspect of the wired media connector, a first set of PCB interface signal line groups may be symmetrical with a second set of PCB interface signal line groups about a PCB interface “inter-group” symmetry line of the PCB interface. Such “inter-group symmetry may aid in PCB routing of the differential signal lines.

Other features and advantages of the present invention will become apparent from the following detailed description of the invention made with reference to the accompanying drawings.

### BRIEF DESCRIPTION OF THE DRAWINGS

FIG. 1 is a schematic block diagram illustrating a printed circuit board having mounted thereupon a plurality of wired media connectors constructed according to an embodiment of the present invention;

FIG. 2 is a diagrammatic perspective view of a wired media connector constructed according to an embodiment of the present invention;

FIG. 3 is a schematic block illustrating a Printed Circuit Board (PCB) interface structure of a connector constructed according to an embodiment of the present invention;

FIG. 4 is an equivalent circuit diagram representing a connector constructed according to a first embodiment of the present invention;

FIG. 5 is an equivalent circuit diagram representing a connector constructed according to a second embodiment of the present invention; and

FIG. 6 is a schematic block illustrating a PCB interface structure of a connector constructed according to another embodiment of the present invention.

### DETAILED DESCRIPTION OF THE DRAWINGS

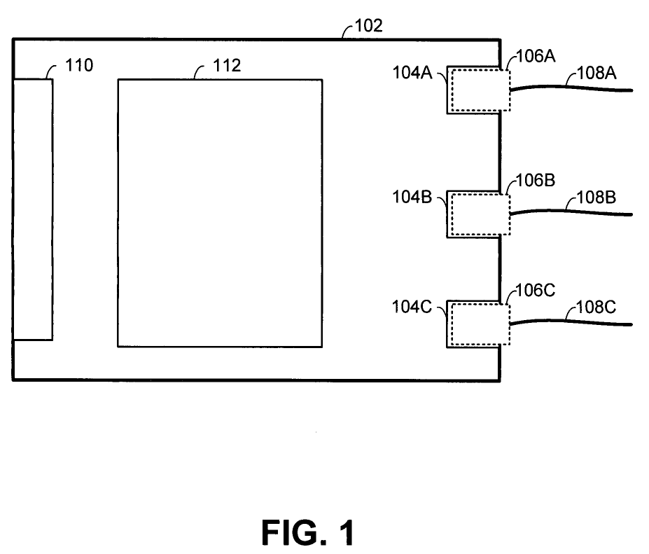

FIG. 1 is a schematic block diagram illustrating a printed circuit board having mounted thereupon a plurality of wired media connectors constructed according to an embodiment of the present invention. The Printed Circuit Board (PCB) 102 has mounted thereon one or more integrated circuits 112, a backplane connector (or bus interface) 110 and a plurality of wired media connectors 104A, 104B, and 104C constructed according to an embodiment of the present invention. Each of these wired media connectors 104A-104C includes a receptacle formed therein that is adapted to receive a wired media plug 106A-106C, respectfully. Each wired media plug 106A-106C couples to a serviced wired media 108A-108C.

The printed circuit board 102 may service a network switch, a network router, a personal computer, or another communication device. When the PCB 102 services a network router or a switch, it will typically include a backplane connector 11O that plugs into a backplane of a rack in which the PCB 102 mounts. When the PCB 102 services a personal computer or laptop computer, the interface 110 would be a bus connector that couples to a PCI bus, a PCI-express bus, a PCMCIA bus, an HT bus, or another bus, for example. In any case, the PCB 102 services wired communications for a serviced host device.

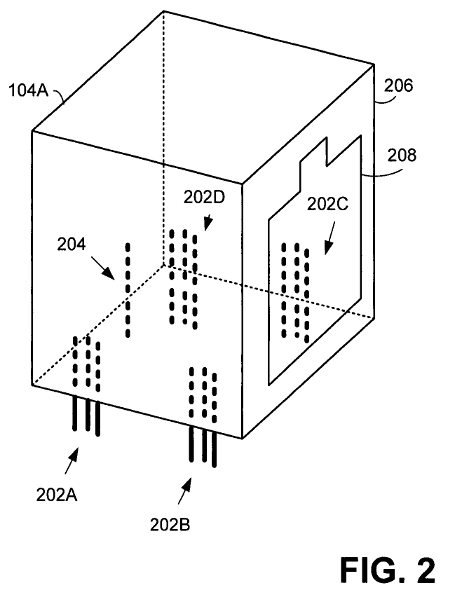

FIG. 2 is a diagrammatic perspective view of a wired media connector 104A constructed according to an embodiment of the present invention. The structure of wired media connector 104A may also correspond to media connector 104B or 104C of FIG. 1. The wired media connector 104A includes a body 206 that is formed of an insulative material and that may include shielding to guard the body 206 from electromagnetic interference (EMI). Formed in the body 206 is a receptacle 208 having a plurality of signal line contacts formed therein to exactly meet a plurality of signal line contacts of a wired media plug, e.g., 106A. The plurality of signal contacts corresponds to a plurality of sets of differential signal lines. When the wired media connector 104A services an Ethernet network, for example, the wired media may be an RJ-45 connector that couples to a supporting wired media. In such case, the media may be Category 5 cabling that includes four pairs of signal lines, shielding, jacketing, and in some cases ground lines.

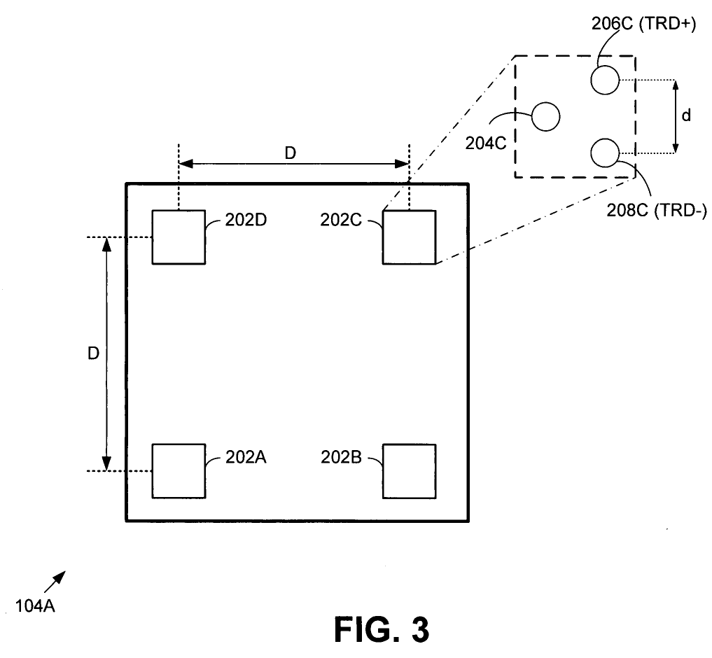

A PCB interface is generally shown to be formed on a bottom portion of the wired media connector 104A. The PCB interface includes a plurality of PCB interface signal line groups 202A, 202B, 202C, and 202D. These PCB interface signal line groups 202A-202D will be described further with reference to FIGS. 3 through 5. Further included with the wired media connector 104A is a grounding/shielding PCB connection 204 that couples the wired media connector 104A to a ground of the PCB 102 upon which the wired media connector 104A mounts. In order to reduce EMI that may be coupled to the signal lines, the body 206 may further have formed therein shielding that couples to the PCB 102 via the grounding/shielding PCB connection 204. Connection 204 can be a multitude of grounding/shielding connections/pins in an arrangement that provides low-impedance ground connection for protection from EMI and crosstalk.

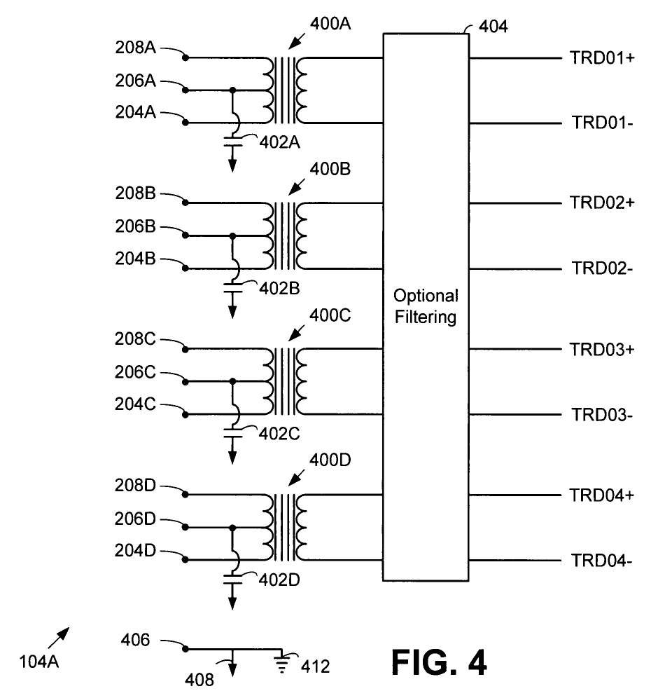

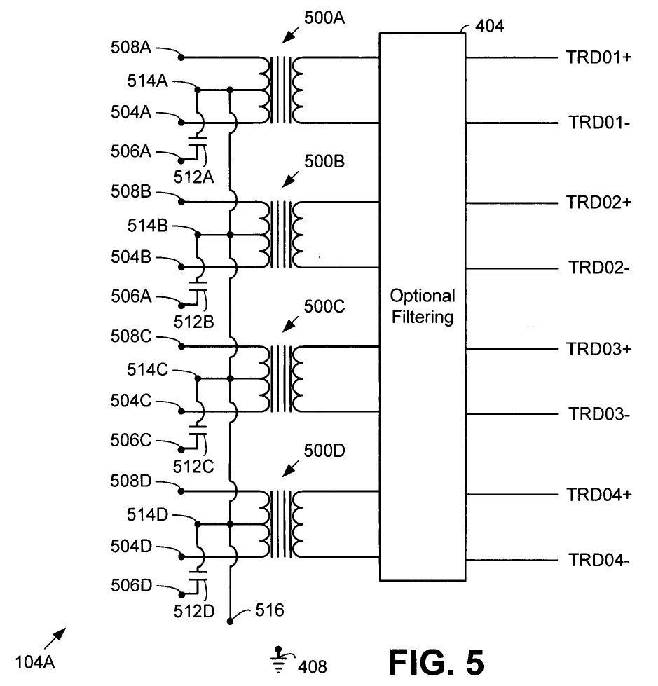

The wired media connector 104A also includes a plurality of isolation transformers contained within the body 204 (not shown in FIG. 2 but shown and described further with reference to FIGS. 3-5). Each isolation transformer includes a primary side (e.g. the side that connects to the wired media 108A-108C in FIG. 1) and a secondary side (e.g. the side that connects to the printed circuit board 102 in FIG. 1). The primary side includes a pair of primary differential signal line connections that communicatively couple to a corresponding set of differential signal lines of the plurality of wired media such as 108A-108C in FIG. 1. The secondary side includes a pair of secondary differential signal line connections and a center tap. These isolation transformers will be described further with reference to FIG. 4 and FIG. 5.

FIG. 3 is a schematic block illustrating a PCB interface structure of a connector constructed according to an embodiment of the present invention. Each PCB interface signal line group 202A-202D includes a pair of differential signal line connections, e.g., 206C and 208C that communicatively couples to a pair of secondary differential signal line connections of a corresponding isolation transformer. Further, a center tap PCB connection 204C of the PCB interface signal line group 202C couples to the center tap of the secondary side of the corresponding isolation transformer.

As is shown in FIG. 3, the plurality of PCB interface signal line groups 202A-202D are separated by a first distance D. Further, the pair of PCB differential signal line connections, e.g., 206C and 208C, of each PCB interface signal line group are separated by a second distance, d. According to the present invention, the first distance D is substantially greater than the second distance d. In one particular embodiment, the first distance D is at least three times the second distance d. The prior art solution did not provide close coupling within each pair and considerable separation between the pairs, which did not minimize crosstalk and impedance imbalance.

As is also shown in FIG. 3, the plurality of PCB interface signal line groups 202A-202D are dispersed and spaced apart on one side of body 206. By spacing apart the plurality of PCB interface signal line groups 202A-202D, cross-coupling between the signal lines of the PCB interface signal line groups is minimized. Further, by having the center tap PCB connection proximate to the pair of PCB differential signal line connections 206C and 208C of the PCB interface signal line group 202C, EMI protection is significantly increased. Further, with the structure of FIG. 3, the signal pins of the PCB interface signal line groups 202A-202D are symmetrical with respect to the signal pins of other PCB interface signal line groups. This symmetry of the differential signal lines of the connector improves impedance balance of the differential pairs, thus reducing crosstalk and EMI. The arrangement with closely spaced pins also allows for improvements in impedance matching and makes easier desired characteristic impedance matching from the perspective of the wired media plug and supported wired media.

By bringing out the center tap of each isolation transformer to the PCB interface along with the serviced differential pair of PCB differential signal lines, the loop area between the pair of PCB differential signal lines and the center tap PCB connection is minimized. This minimizes the inductance of the center tap to maximize EMI suppression by the center tap. Prior devices tied center taps of the isolation transformers either together and used only one center tap pin, or used the center tap pins and differential pair pins in a nonsymmetrical and not closely coupled arrangement. This prior art solution required long lead lines to reach the common ground increasing inductance on the center taps tie thereby decreasing the EMI suppression provided by the prior connectors. The prior art solution also did not preserve symmetry and impedance balance of the differential pairs through the connector pins.

FIG. 4 is an equivalent circuit diagram representing a connector 104A constructed according to a first embodiment of the present invention. The equivalent circuit includes isolation transformers 400A-400D, PCB interface connections thereto, and optional filtering circuitry 404 coupled to the primary sides of the plurality of isolation transformers 400A-400D. Sets of differential signal lines TRD01+ and TRD01−, TRD02+ and TRD02−, TRD03+ and TRD03−, and TRD04+ and TRD04− couple to the optional filtering circuitry 404 and represent the differential signaling serviced by the wired media connector 104A.

According to the embodiment of FIG. 4, the primary side of each isolation transformer 400A-400D (in combination with the corresponding signal contacts of the receptacle 208, in some embodiments) has/have a characteristic impedance that matches a serviced wired media. For example, RJ-45 wired media has a differential characteristic impedance of 100 Ohms. Thus, the wired media connectors 104A-104C present this 100 Ohm characteristic impedance to the plugs 106A-106C to minimize reflections of differential signals carried thereon.

In the embodiment of FIG. 4, each isolation transformer 400A-400D has a corresponding pair of secondary differential signal line connections 204A and 208A, 204B and 208B, 204C and 208C, and 204D and 208D, respectively. Further, the secondary of each isolation transformer 400A-400D includes center taps 206A, 206B, 206C, and 206D, respectively. According to the embodiment of FIG. 4, each isolation transformer 400A-400D has further associated therewith a capacitor 402A-402D, respectively. Referring to isolation transformer 400A, corresponding capacitor 402A has a first side coupled to the center tap of the isolation transformer 400A and a second side coupled to a ground of the wired media connector (and to PCB 102). Such coupling provides additional EMI protection for the particular wired media connector embodiment. Each other isolation transformer 400B-400D includes a corresponding capacitor 402B-402D. Further included with the embodiment of FIG. 4 is a shielding connection 406, a ground 408, and a shield ground 412.

FIG. 5 is an equivalent circuit diagram representing a connector constructed according to a second embodiment of the present invention. Referring now to FIG. 5, in the embodiment of FIG. 5, isolation transformers 500A-500D include commonly tied center taps 514A-514D, respectively. These commonly tied center taps 514A-514C have a common connection 516 that is brought out so that it may be tied to ground or otherwise connected. Further, coupled to the center tap 514A-514D of each isolation transformer 500A-500D is a coupling capacitor 512A-512D, respectively, that couples the center tap to respective center tap connections 506A-506D. The secondary of each of these isolation transformers 500A-500D further includes a corresponding pair of secondary differential signal line connections 504A and 508A, 504B and 508B, 504C and 508C, and 504D and 508D, respectively.

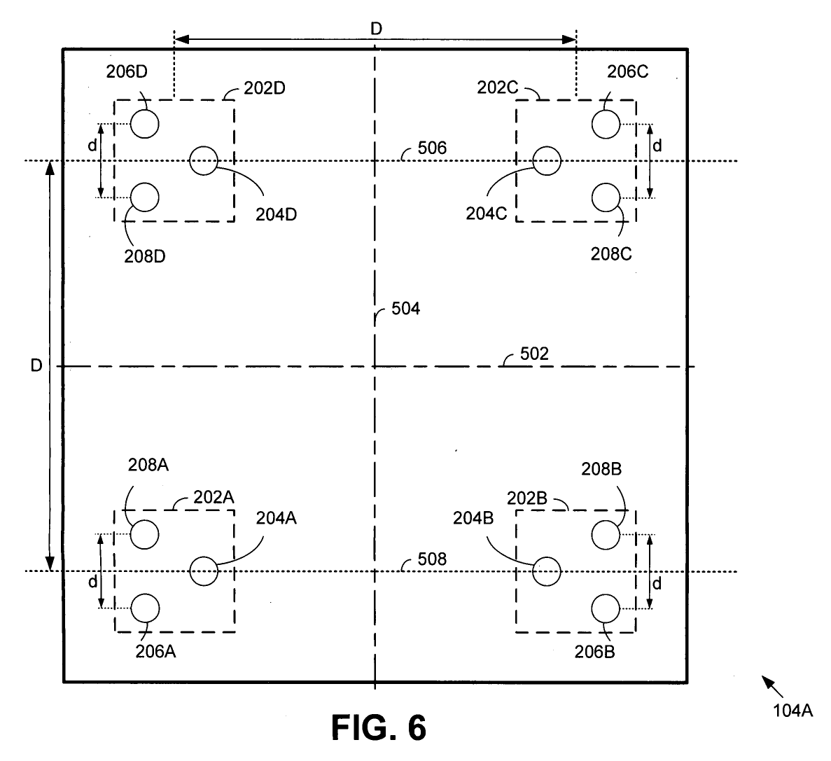

FIG. 6 is a schematic block illustrating a PCB interface structure of a connector, e.g., 104A, constructed according to another embodiment of the present invention. The components illustrated in FIG. 6 that are same as/similar to the components of FIG. 3 have retained common numbering. Thus, each PCB interface signal line group (pin grouping) 202A-202D includes a pair of differential signal line connections (differential signal line pins), e.g., 206C and 208C that communicatively couples to a pair of secondary differential signal line connections of a corresponding isolation transformer. Further, a center tap PCB connection, e.g., 204C, of the PCB interface signal line group 202C couples to the center tap of the secondary side of the corresponding isolation transformer.

The plurality of PCB interface signal line groups 202A-202D is separated by a first distance D. Further, the pair of PCB differential signal line connections, e.g., 206C and 208C, of each PCB interface signal line group are separated by a second distance, d. According to the present invention, the first distance D is substantially greater than the second distance d. In one particular embodiment, the first distance D is at least three times the second distance d.

For each PCB interface signal line group, e.g., 202C, the pair of PCB differential signal line connections, e.g., 206C and 208C may be symmetric about a PCB interface intra-group symmetry line 506 that bisects the center tap PCB connection 204C. The intra-group symmetry line 506 may indicate symmetry for multiple PCB interface signal line groups (pin groupings) 202C and 202D as is illustrated in FIG. 6. Further, intra-group symmetry line 508 may indicate symmetry for multiple PCB interface signal line groups (pin groupings) 202A and 202A. The intra-group symmetry of FIG. 6 increases balance of the differential pins/connections and increases EMI protection.

Shown in FIG. 6 are manners in which the signal line groups/pins of the PCB interface may be symmetrically located. According to another aspect of such symmetry of the PCB interface 104A, a first set of PCB interface signal line groups 202A and 202D is symmetrical with a second set of PCB interface signal line groups 202B and 202C about a PCB interface inter-group symmetry line 504. According to another aspect of such symmetry of the PCB interface 104A, a first set of PCB interface signal line groups 202A and 202B is symmetrical with a second set of PCB interface signal line groups 202C and 202D about a PCB interface inter-group symmetry line 502. Of course, in other embodiments, other PCB interface inter-group symmetry lines may exist, such symmetry improving balance of the connector. Inter-group symmetry may make PCB routing of differential signal lines (and ground lines) easier. Of course, inter-group symmetry (or intra-group symmetry) is not a requirement of a connector constructed according to an embodiment of the present invention.

As one of average skill in the art will appreciate, the term “substantially” or “approximately,” as may be used herein, provides an industry-accepted tolerance to its corresponding term. Such an industry-accepted tolerance corresponds to, but is not limited to, component values, integrated circuit process variations, temperature variations, rise and fall times, and/or thermal noise. As one of average skill in the art will further appreciate, the terms “communicatively coupled” or “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled.” As one of average skill in the art will further appreciate, the term “compares favorably,” as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The invention disclosed herein is susceptible to various modifications and alternative forms. Specific embodiments therefore have been shown by way of example in the drawings and detailed description. It should be understood, however, that the drawings and description thereto are not intended to limit the invention to the particular form disclosed, but on the contrary, the invention is to cover all modifications, equivalents, and alternatives falling within the spirit and scope of the present invention as defined by the claims.

1. A wired media connector comprising:
a body;
a receptacle formed in the body having a plurality of signal line contacts formed to exactly meet a plurality of signal line contacts of a wired media plug, the plurality of signal contacts corresponding to a plurality of sets of differential signal lines;
a plurality of isolation transformers contained within the body, each isolation transformer comprising:
a primary side having a pair of primary differential signal line connections communicatively coupled to a corresponding set of differential signal lines of the plurality of sets of differential signal lines; and
a secondary side having a pair of secondary differential signal line connections and a center tap; and
a Printed Circuit Board (PCB) interface formed on the body and having a plurality of PCB interface signal line groups, each PCB interface signal line group comprising:
a pair of PCB differential signal line connections communicatively coupled to the pair of secondary differential signal line connections of a corresponding isolation transformer; and
a center tap PCB connection communicatively coupled to the center tap of the secondary side of the corresponding isolation transformer.

2. The wired media connector of claim 1, wherein the secondary side of each isolation transformer in combination with corresponding signal contacts of the receptacle has a characteristic impedance matched to a serviced wired media.

3. The wired media connector of claim 1, further comprising, for each isolation transformer, a capacitor having a first side coupled to the center tap of the isolation transformer, and a second side coupled to a ground of the wired media connector.

4. The wired media connector of claim 1, further comprising filtering circuitry coupled to the primary side of the plurality of isolation transformers.

5. The wired media connector of claim 1, wherein:
the plurality of PCB interface signal line groups are separated by a first distance D;
the pair of PCB differential signal line connections of each PCB interface signal line group are separated by a second distance d; and
the first distance D is substantially greater than the second distance d.

6. The wired media connector of claim 5, wherein the first distance D is at least three times the second distance, d.

7. The wired media connector of claim 1, further comprising, for each isolation transformer, a capacitor having a first side coupled to the center tap of the isolation transformer and a second side coupled to a corresponding center tap PCB connection.

8. The wired media connector of claim 1, wherein a first set of PCB interface signal line groups is symmetrical with a second set of PCB interface signal line groups about a PCB interface inter-group symmetry line of the PCB interface.

9. The wired media connector of claim 1, wherein for each PCB interface signal line group, the pair of PCB differential signal line connections is symmetric about a PCB interface intra-group symmetry line that bisects the center tap PCB connection.

10. A wired media connector having board pins corresponding to a plurality of differential signal line pairs and center taps, the wired media connector comprising:
a plurality of pin groupings, each pin grouping corresponding to a differential signal line pair of the plurality of differential signal line pairs, having a pair of differential signal line pins, and a separate center tap pin; and
wherein each pin grouping of the plurality of pin groupings is separated from each other pin grouping of the plurality of pin groupings by a distance sufficient to minimize interference between differential signal line pairs of differing pin groupings.

11. The wired media connector of claim 10, wherein
the pin groupings are separated from one another by at least a first distance D;
the pair of differential signal line pins in each pin grouping are separated by a second distance d; and
the first distance D is greater than the second distance d.

12. The wired media connector of claim 11, wherein the first distance D is at least three times the second distance, d.

13. The wired media connector of claim 10, wherein a first set of pin groupings is symmetrical with a second set of pin groupings about an inter-group symmetry line of the wired media connector.

14. The wired media connector of claim 10, wherein for each pin grouping, the pair of differential signal line pins is symmetric about an intra-group symmetry line that bisects the center tap pin.

15. A wired media connector operable to exactly meet a wired media plug that services a wired media having a plurality of differential signal line pairs, the wired media connector comprising:
a body;
a receptacle formed in the body having a plurality of signal line contacts formed to exactly meet a plurality of signal line contacts of the wired media plug;
a plurality of isolation transformers each comprising:
a primary side having a pair of primary differential signal line connections communicatively coupled to a corresponding set of differential signal lines of the plurality of differential signal line pairs; and
a secondary side having a pair of secondary differential signal line connections and a center tap; and
a Printed Circuit Board (PCB) interface formed on the body and having a plurality of pin groupings, each pin grouping corresponding to a differential signal line pair of the plurality of differential signal line pairs, having a pair of differential signal line pins, and a separate center tap pin, wherein each pin grouping of the plurality of pin groupings is separated from each other pin grouping of the plurality of pin groupings by a distance sufficient to minimize interference between differential signal line pairs of differing pin groupings.

16. The wired media connector of claim 15, wherein
the pin groupings are separated from one another by at least a first distance D;
the pair of differential signal line pins in each pin grouping are separated by a second distance d; and
the first distance D is greater than the second distance d.

17. The wired media connector of claim 16, wherein the first distance D is at least three times the second distance, d.

18. The wired media connector of claim 15, wherein a first set of pin groupings is symmetrical with a second set of pin groupings about an inter-group symmetry line of the wired media connector.

19. The wired media connector of claim 15, wherein for each pin grouping, the pair of differential signal line pins is symmetric about an intra-group symmetry line that bisects the center tap pin.

20. The wired media connector of claim 15, further comprising, for each isolation transformer, a capacitor having a first side coupled to the center tap of the isolation transformer, and a second side coupled to a ground of the wired media connector.
